(19) United States
(12) Patent Application Publication
(10) Pub. No.: US 2012/0022199 A1
(43) Pub. Date: Jan. 26, 2012

(54) ANTI-AGING CHEMICALS FOR HIGH SOLIDS LOADING SLURRIES

(75) Inventors: Wolfgang M. Sigmund, Gainesville, FL (US); Joshua J. Taylor, Cape Canaveral, FL (US)

(73) Assignee: University of Florida Research Foundation, Inc., Gainesville, FL (US)

(21) Appl. No.: 13/145,709

(22) PCT Filed: Jan. 22, 2010
(86) PCT No.: PCT/US2010/021699

§ 371 Date: Jul. 21, 2011

Related U.S. Application Data
(60) Provisional application No. 61/146,883, filed on Jan. 23, 2009.

(51) Int. Cl. C08L 33/02; C08K 5/053; C08K 3/26

(52) U.S. Cl. 524/387; 524/560; 524/425; 524/388

(57) ABSTRACT

Water structure breakers are included with dispersants in high solids aqueous slurries to stabilize the aqueous solution structure over a long period of time. The incorporation of a dispersant and a water structure breaker effectively inhibits the viscosity increase typically associated with high solid slurries, such as ground calcium carbonate (GCC) slurries, The inclusion of a small amount of water structure breaker inhibits change in the solution structure over that of a typical slurry lacking the water structure breaker, allowing longer storage and distribution periods for such slurries.

### CROSS-REFERENCE TO A RELATED APPLICATION

This application claims the benefit of U.S. Provisional Application Serial No. 61/146,883, filed Jan. 23, 2009, the disclosure of which is hereby incorporated by reference in its entirety, including all figures, tables and drawings.

### BACKGROUND OF THE INVENTION

Worldwide more than 70 metric tons of ground calcium carbonate (GCC) is produced per year, where nearly 80% is used as filler in paper, plastics paints, sealants and adhesives. Much of the growth in capacity has been devoted to producing grades of GCC for paper coating. Paper accounts for around 38% of world demand and plastics account for an additional 20% of demand. Papermakers commonly use ground limestone products that are “fine-ground” or “ultrafine-ground” where 60% to 90% of the equivalent particle size is smaller than 2 μm based on their sedimentation rates.

GCC plants are typically sited near sources of limestone, marble or chalk and the product is stored and shipped to the user as a slurry in water. To minimize cost of transportation and drying, high solids slurries are formed, and the industries goal is to have the highest loading of GCC with the lowest possible viscosity. Although GCC is generally non-hazardous, unstirred tanks and pipes containing stagnant GCC slurry can lead to sites of dense sedimentation that are very difficult to resuspend. In some cases the thickening of the slurry can be so severe that it can be difficult, if not impossible, to empty tank trucks or tank rail cars by gravity discharge when the slurry stands for more than about eight hours. This problem can be very pronounced with finely ground high solids GCC slurries bleached with reductive bleaching agents.

To lessen the problem of sedimentation, GCC slurries include a dispersant, usually at a level of about 1% or less as the cost of the dispersant can be prohibitive for many uses of GCC. Common dispersants are low molecular weight acrylic polymers and copolymers with different molecular weights, molecular weight distributions and degree of neutralization. However, even with state of the art acrylic homopolymer anionic dispersants of molecular weight less than 4,000, unstirred slurry can more than double its viscosity when aged for a single week.

In spite of significant effort in development of dispersants, cost effective anti-aging methods and formulations are needed to expand the use of GCC to many application and to improve the cost and reliability of fine GCC slurries.

### BRIEF SUMMARY OF THE INVENTION

An embodiment of the invention is directed to a method to inhibit viscosity increases of high solids slurries upon aging. The method involves combining a particulate solid with a solution containing water, at least one dispersant and at least one water structure breaker. The water structuring around the particulate solid is inhibited due to the addition of the water structure breaker. In one embodiment the particulate solid is calcium carbonate, for example ground calcium carbonate. A slurry can be prepared to have 70 to 85 percent or more particulate solid by weight. Common dispersants, such as sodium salts of an acrylate polymers or copolymers can be use at levels less than 1 percent, for example 0.1 to 2 percent. The water structure breaker can be a di- tri- or tetra-alcohol, low molecular weight polyethylene glycols, or salts such as K₂CO₃, Cs₂CO₃, Rb₂CO₃, KCl, RbCl, CsCl, KBr, RbBr, CsBr, KI, RbI, and CsI. For example, ethylene glycol can be used at levels of 0.1 to about 5 percent of the slurry.

Another embodiment of the invention is directed to the stabilized slurry comprising the components combined in the above method. Hence, a stabilized slurry contains water, at least one particulate solid, at least one dispersant, and at least one water structure breaker. Such a slurry is very stable for extended periods of time relative to an equivalent slurry that omits the water structure breaker.

### BRIEF DESCRIPTION OF THE DRAWINGS

FIG. 1 is a composite trace of overlaid FTIR spectra of the O-D band of deuterated water for a 75 weight percent GCC slurry with a poly(acrylic acid) sodium salt (PAAS) dispersant aged for less than 1, 25, and 51 hours with a spectrum of a PAAS free GCC slurry in D₂O.

FIG. 2 is a composite trace of overlaid FTIR spectra of the O-D band of water for a 75 weight percent GCC slurry containing ethylene glycol immediately after preparing the slurry and after aging for 64 hours.

FIG. 3 shows plots of 75 weight percent slurries of GCC with a dispersant with and without added ethylene glycol after 48 hours as a function of shear rate.

### DETAILED DESCRIPTION OF THE INVENTION

The stabilization of high solids slurries is carried out by the stabilization of the liquid aqueous phase structure. Traditionally, the focus has been on the stabilization of the interface between the solid particle and the aqueous phase. It has been discovered that by inclusion of an agent to inhibit changes in the aqueous solution's structure, the slurry is stable and does not undergo the adverse changes with aging that complicate the use of the slurries. In an embodiment of the invention, an aqueous suspension of ground calcium carbonate (GCC) is stabilized by the inclusion of a small amount of a dispersant and a small amount of a water structure breaker, which stabilizes the structure of the aqueous phase, as can be monitored by infrared spectroscopy. For example, in one embodiment of the invention, the dispersant can be the sodium salt of polyacrylic acid and the water structure breaker can be ethylene glycol. The inclusion of the water structure breaker has been found to stabilize GCC slurries against the common symptoms of aging, particularly an increase in viscosity of the slurry. In other embodiments, the particulate solid can be any solid that can be dispersed with an increase in entropy due to the release of structured water molecules from the solid surface. The particulate solid can be precipitated calcium carbonate, kaolin, titanium dioxide, silica, other effectively water insoluble salts, or any combination thereof. In one embodiment, the particulate solid can be precipitated calcium carbonate (PCC) or a mixture of PCC with GCC.

The GCC or other solid particle can have a significant fraction of the particles that are less than 2 μm in diameter, for example, the GCC can have 90% or more of the particles being less than 2 μm in diameter. The particles can be loaded in excess of 70 weight percent of the slurry and can be in excess of 80, 85, or even 90 weight percent of the slurry although lower levels of particulates can be used.

The dispersant that can be included in the slurry can be poly-salts of polyacrylate or polymethacrylate comprising polymers or copolymers. Polyacrylates can have molecular weights of about 1,000 to 20,000 or even to 100,000. The salts can be those with alkali metal cations or ammonium cations. Other polyelectrolyte dispersants that can be used include, for example, salts of polymaleic acid or polyaspartic acid comprising polymers and copolymers. The dispersant can be a mixture of dispersants. The dispersant can be used at loadings of less than two percent by weight. The dispersant can be used at loadings of less than one percent by weight.

By the inclusion of ethylene glycol, or other chemicals that can inhibit the change of the water structure, the slurry is stabilized. Other water structure breakers can be used in place of, or in addition to, ethylene glycol as the agent to inhibit changes in the aqueous solution structure include propylene glycol and other water soluble di- tri- or tetra-alcohols. Low molecular weight polyethylene glycols can be used as water structure breakers. Salts such as K₂CO₃, Cs₂CO₃, Rb₂CO₃, KCl, RbCl, CsCl, KBr, RbBr, CsBr, KI, RbI, and CsI can be used as water structure breakers. Combinations of various water structure breakers can be used as the water structure breaker. The agent for inhibiting the structuring of the water, such as ethylene glycol, can be included at five percent or less and although higher levels of ethylene glycol or other water structure breakers to inhibit changes in the aqueous solution structure can be used, the lower levels are generally sufficient for stabilization. For example, the agent can be used at 0.2, 0.3, 0.4, 0.5, 0.6, 0.7, 0.8, 0.9, 1.0, 1.5, 2, 2.5, 3, 3.5, 4, 4.5 or 5% by weight.

### MATERIALS AND METHODS

Attenuated Total Reflectance Fourier Transform Infrared Spectroscopy (ATR-FTIR) was carried out to demonstrate that the aging of a GCC suspension is accompanied by a change in the structure of water solutions and that these changes can be inhibited by a dispersant and a water structure breaker. The dispersant was a commercial sodium salt of polyacrylic acid, KK-7-44 by Kemira Chemicals, Inc, Kennesaw, Ga., used at 1 weight percent. To perform this analysis, deuterated water (D₂O) was used to prepare an aqueous solution and the bands from 2200 to 2700 cm⁻¹ were observed for the slurries prepared with the deuterated water over time.

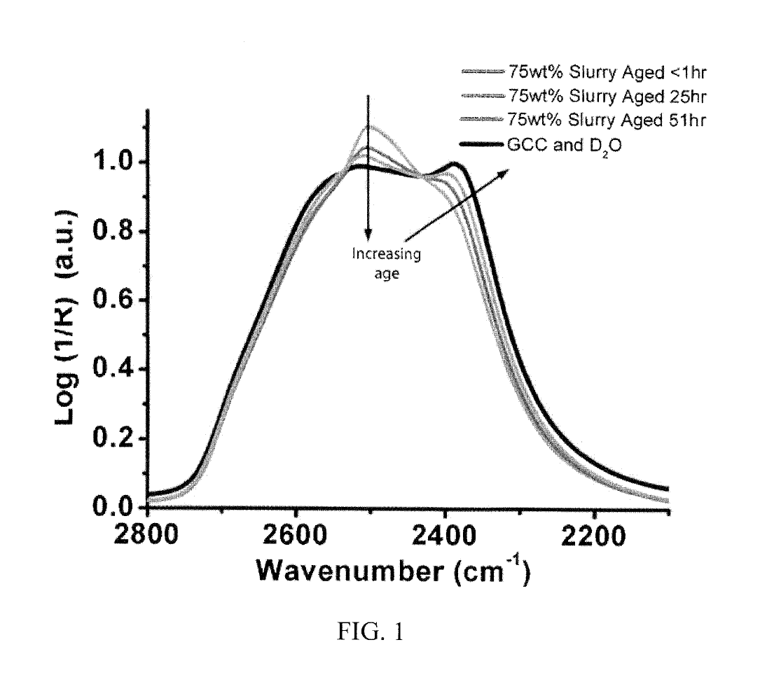

FIG. 1 displays overlaid FTIR spectra, where one spectrum is that of a relatively freshly prepared, <1 hour old, 75% slurry of GCC was scanned. The slurry was prepared using the dispersant, but without the water structure breaker. Other overlaid spectra were taken after 25 and 51 hours. These spectra were compared with those of a slurry of GCC in D₂O prepared without a dispersant, where the band from the water of the solid-like hydrated CaCO₃ aggregate at about 2380 cm⁻¹ was clearly seen. In a freshly prepared slurry, a strong fluid-like associated D₂O band at 2500 cm⁻¹ can he readily seen. As the slurry aged, the band at 2500 cm⁻¹ diminishes in intensity and the solid-like association band at 2380 cm⁻¹ builds. This spectral change is accompanied by a significant viscosity increase.

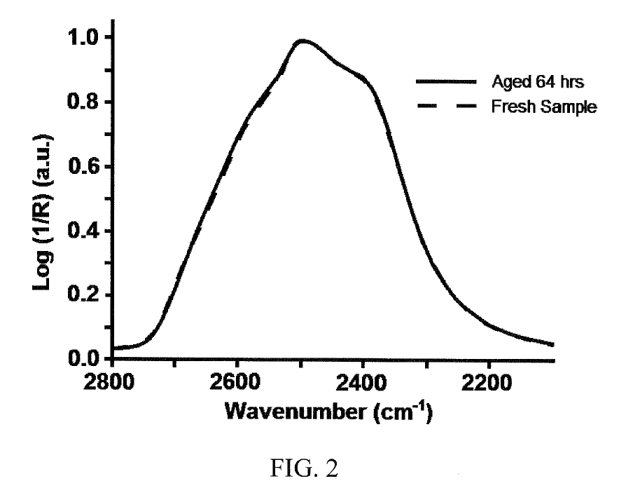

FIG. 2 shows a pair of FTIR spectra for a 75 weight percent GCC slurry that contains 0.5 M, about 3 weight percent, ethylene glycol and 1 weight percent KK-7-44 for the freshly prepared and for the 64 hour aged slurry. The two spectra were nearly identical with no indication of the increase of the signal for the solid-like association. The pair of spectra was nearly superimposable with that of the freshly prepared slurry of FIG. 1 and the viscosity did not increase over the 64 hour period.

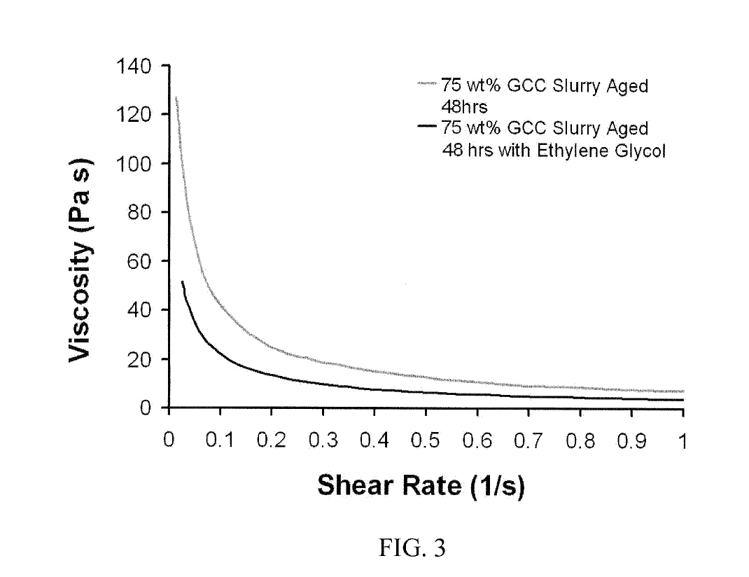

FIG. 3 shows the viscosity of 75 weight percent slurries of GCC with the dispersant at 1 weight percent with and without ethylene glycol after 48 hours as a function of shear rate. The viscosity of the slurry with ethylene glycol was approximately half that of the viscosity for the slurry without ethylene glycol over all shear rates.

Hence, adverse effects associated with aging of high solids slurries can be inhibited by the inclusion of an agent that inhibits structural changes of the aqueous solution. By inhibiting the aqueous solutions structural changes, slurries can be stable for a long period of time.

All patents, patent applications, provisional applications, and publications referred to or cited herein, supra or infra, are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method to inhibit viscosity increases with aging of high solids slurries comprising the steps of:
providing at least one particulate solid; and
combining said particulate solid with a solution comprising water, at least one dispersant and at least one water structure breaker wherein water structuring around said particulate solid is inhibited.

2. The method of claim 1, wherein the particulate solid comprises calcium carbonate.

3. The method of claim 2 wherein said calcium carbonate comprises ground calcium carbonate.

4. The method of claim 1, wherein the particulate solid is 65 to 85 percent by weight.

5. The method of claim 1, wherein said dispersant comprises a sodium salt of an acrylate comprising polymer or copolymer.

6. The method of claim 5, wherein said dispersant is about 0.1 to about 2 percent by weight.

7. The method of claim 1, wherein said water structure breaker is a di- tri- or tetra-alcohol.

8. The method of claim 7, wherein said di-alcohol is ethylene glycol.

9. The method of claim 1, wherein said water structure breaker is 0.1 to 5 percent by weight.

10. A stabilized slurry comprising: water; at least one particulate solid; at least one dispersant; and at least one water structure breaker wherein change in the water structure around said particulate solid is inhibited.

11. The stabilized slurry of claim 10, wherein said water structure breaker comprises a di- tri- or tetra-alcohol.

12. The stabilized slurry of claim 11, wherein said di-alcohol is ethylene glycol.

13. The stabilized slurry of claim 10, wherein said water structure breaker is 0.1 to 5 percent by weight.

14. The stabilized slurry of claim 10, wherein the particulate solid comprises calcium carbonate.

15. The stabilized slurry of claim 14, wherein said calcium carbonate comprises ground calcium carbonate.

16. The stabilized slurry of claim 10, wherein the particulate solid is 70 to 85 percent by weight.

17. The stabilized slurry of claim 10, wherein said dispersant comprises a sodium salt of an acrylate comprising polymer or copolymer.

18. The stabilized slurry of claim 17, wherein said dispersant is less than about 2 percent by weight.
